(19) United States
(12) Patent Application Publication
(10) Pub. No.: US 2008/0141869 A1
(43) Pub. Date: Jun. 19, 2008

(54) Arrangement For a Grill

(76) Inventor: Tadaharu Ikeda, Estado de Sao Paulo (BR)

Correspondence Address: MICHAEL J. STRIKER, 103 EAST NECK ROAD, HUNTINGTON, NY, 11743, US

(21) Appl. No.: 11/575,581

(22) PCT Filed: Sep. 23, 2004
(86) PCT No.: PCT/BR2004/000181

§ 371 Date: Sep. 11, 2007

(51) Int. Cl. A47J 37/07

(52) U.S. Cl. 99/447

(57) ABSTRACT

The present abstract refers to the application for a utility model patent covering a grill belonging to the field of home utensils, which received an arrangement to enable the preparation of a barbecue to the “open flame” style in a gas oven, essentially comprising: a base platter (1) supported over the gas burner (50) of an oven and provided with a middle opening (4) receiving the flame; a bell-shaped container (10), which is coupled and supported over the base platter (1); a heat diffuser (20) supported over the base platter (1) above the opening (4) and receiving an amount of charcoal (52); and a set of vertical skews (30) and baskets (31) with the tips supported over circumferential braces (6) of the base platter (1) around the opening (4); said skews and baskets remaining with intermediate sections supporting the meat along the bell-shaped container (10), and upper outer ends close to the cables, coupled with upper streaks (16) extending radially from the upper opening (14) of the bell-shaped container (10) which receives the cap (15).

The present specification refers to an application for the grant of a utility model patent for a grill, an object belonging to the field of the home utensils, and which received an arrangement in order to enable preparing the barbecue to the so-called “open flame” style using an oven.

One of the most traditional ways of preparing a barbecue to the so-called “open flame” style, according to which cuts of meat are fixed to skews or grilling baskets, and which are then arranged vertically around the flame.

Market surveys have found out that it would be desirable having a equipment that could enable the transfer of such traditional way of barbecuing to modern food preparation means, including a gas oven.

Such surveys have also shown that it would be desirable that such barbecue equipment could provide the meat with the traditional barbecue “open flame” taste; not produce smoke during its use; be portable, easy-to-use and easy-to-clean, and also capable of meeting other specifications required by modern home tools.

Thus, the objective of the arrangement object of the present application for a utility model patent is to provide a portable, dismountable grill for the preparation of “open flame” style barbecue, and which can be used in gas ovens, whose construction, working and advantages are described below on basis of the attached drawings, in which:

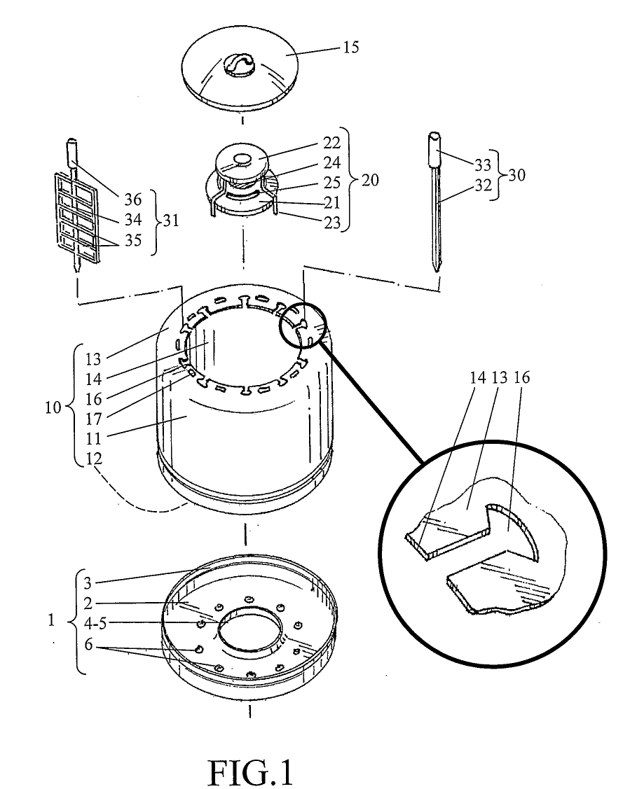

FIG. 1 shows an exploded perspective view of the grill, and an enlarged detail showing the skew supporting hole;

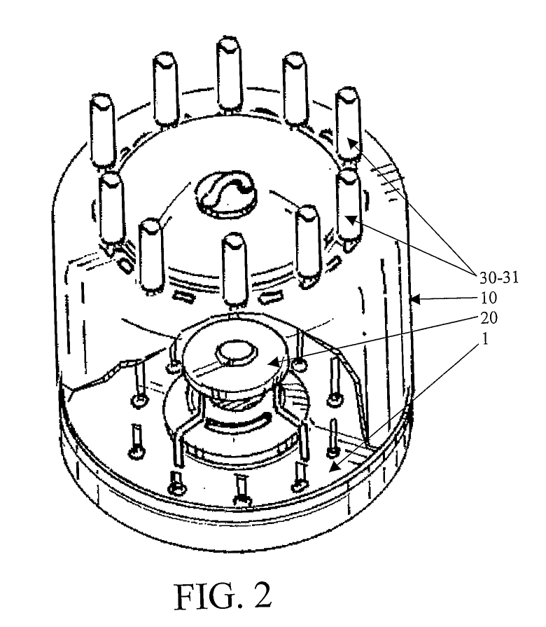

FIG. 2 shows the grill as mounted, and a partial section thereof;

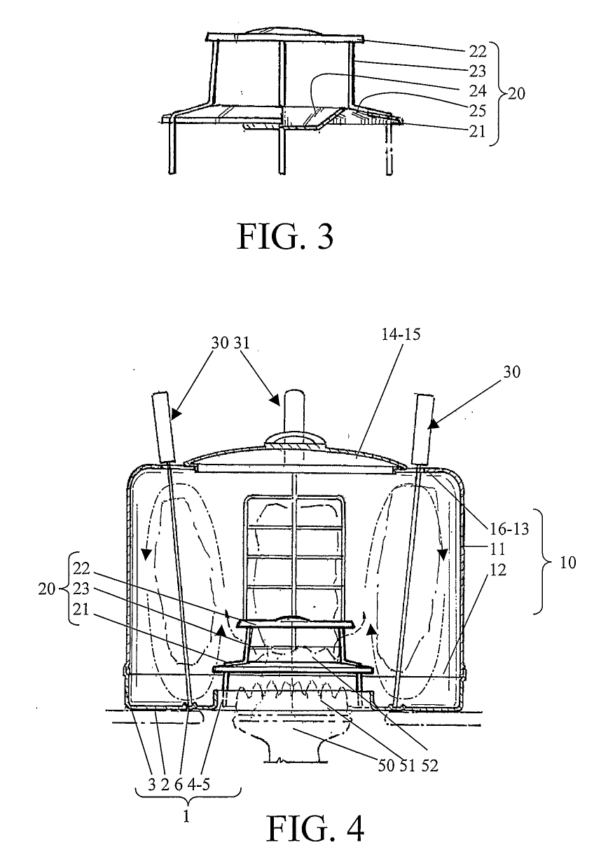

FIG. 3 shows a detail of the grill diffuser with a partial section; and

FIG. 4 shows a section view of the grill as mounted and the use indication.

According to the above-mentioned drawings, the grill object of the present application for a utility model patent is intended to “open flame” barbecue in a gas oven, which essentially comprises: a base platter 1; a bell-shaped container 10; a heat diffuser 20; and a set of skews 30 and vertical baskets 31.

The base platter 1 is formed by: a bottom part 2 selected to be supported over a gas burner 50 of a gas oven; and a not too high peripheral wall 3, where the upper bell-shaped container 10 is coupled and supported; such bottom part 2 being provided with: a middle opening 4 for receiving the flame from the gas burner 50, and surrounded by an inner directing edge 5; and a plurality of circumferential rib-shaped braces 6 for supporting the skew tips 30 or baskets 31, such braces being regularly arranged following a circumferential alignment around the middle opening 4.

A bell-shaped container 10 is defined by a cylindrical wall 11 provided with an open lower end 12, which is internally coupled and fixed to the wall 3 of the base platter 1; and a upper wall 13 extending from the cylindrical wall provided with a wide middle opening 14, which receives the closing cap 15; said upper wall 13 is further provided with streaks 16 for supporting the skews 30 or baskets 31 arranged correspondingly to the respective circumferential ribs 6 supporting the skew tips 30 and baskets 31 located in the base platter 1. Each streak 16 consists of a rectilinear section radially extending from the middle opening 14, introduction and removal of skews/baskets, and an enlarged end for supporting the skews/baskets. The referred to upper wall 13 is further provided with steam escape streaks 17 each of them arranged between streaks 16 for supporting the skews/baskets.

The heat diffuser 20 is arranged immediately above the middle opening 5 of the base platter 1 and is formed by: a lower platter 21; a upper deflector 22; and feet 23; said lower platter 21 featuring a middle section having the shape of the platter itself 24 supporting an amount of charcoal 52 in order to provide the meat with the typical barbecue taste; and curved, oblong openings 25 arranged around the middle section 24; the upper deflector 22 is disk-shaped and rests above the middle section 24 and openings 25 of the lower platter 21; and feet 23 interconnecting the lower platter 21 with the diffuser 22 having sections projected downwards the lower platter 21, and supported over a section of the base platter 1 around the inner edge 5.

Preferably, the skews 30 comprise a flat rod 32, which pierces the meat to be roasted and a handle 33 located at one end of the rod. The baskets 31 consist of a central rod 34; two articulated baskets 35 mounted on the rod, between which the meat to be roasted is kept fastened, and a handle 36 provided at the rod end. The rod tips 32 and 34 of said skews 30 and baskets 31 are supported over circumferential braces 6 of the base platter 1; the intermediate extensions of said skews and baskets supporting the meat, extend vertically along the bell-shaped container 10 and the upper ends of rods 32 and 34 of said skew and basket located close to handles 33 and 36, get coupled with streaks 16 of the upper wall 13 of the bell-shaped container 10, and the handles 33 and 36 are located above the upper wall 13 of the bell-shaped container. Rods 32 and 34 are preferably flat to work in cooperation with the streaks 16 and provide a better stabilization when arranged at their enlarged ends.

The grill built as described works as follows: the base platter 1 is supported on the gas burner 50 in such way that the flame 51 gets into its middle opening 4. The middle platter 24 of the diffuser 20 receives an amount of charcoal 52, and is supported over the base platter 1 so that the lower platter 21 containing the middle platter 24 and the diffuser 22 are above the middle opening 4 of the base platter 1. The bell-shaped container 10 is coupled inside the peripheral wall 3 of the base platter 1. The skews 30 and baskets 31 holding the meat to be roasted are introduced through the middle opening 14 of the upper wall 13 of the bell-shaped container 10, and their tips are supported over circumferential braces 6 of the base platter 1, and their upper sections located close to handles 33, 36, are coupled with streaks 16 of the upper wall 13 of the bell-shaped container 10. A cap 15 is applied to the opening 14 of the bell-shaped container 10. The gas burner 50 is light. The flame heat ignites the charcoal 52 contained in the middle platter 24, and the diffuser 20 inside the bell-shaped container 10 spreads it all around until reaching up the cuts of meat held by the skews 30 and basket 31 arranged around the middle opening 4 of the base platter 1, and as a consequence, around flame 51 of the gas burner 50. The heat coming from the gas burner and charcoal acts to roast the meat while providing the meat with the taste as if it were prepared with the heat and flame coming from the charcoal only, as occurs with the traditional preparation of the “open flame” barbecue. Furthermore, in order to turn the meat, the skew 30 or basket 31 is removed from the streak 16 through its narrow, rectilinear section, then rotated around itself and reinserted into the streak 16 to stabilize its enlarged end.

Therefore, the grill enables the preparation of a barbecue to the “open flame” style by using modern cooking resources, namely the gas oven.

Further, the fact of using charcoal inside the grill allows the roasted meat to gain a taste similar to that it would if it had been prepared with the traditional barbecue resources.

Further, the grill construction is proper to enable the equipment to be a portable, easy-to-use utensil, further to being easy to clean after the barbecue is done.

According to the basic above-described construction, the grill object of the present application for a utility model patent can incorporate changes related with materials, dimensions, constructive and/or configuration details, without departing from the scope of the protection claimed.

In accordance with the foregoing, the casing may be either split into two parts or made as one single piece.

1)- “ARRANGEMENT FOR A GRILL”, characterized essentially by: a base platter (1); a bell-shaped container (10); a heat diffuser (20); and a set of vertical skews (30) and baskets (31); said base platter (1) being formed by a bottom part (2) selected to be supported over a gas burner (50) of a gas oven; and a not too high peripheral wall (3), where the upper bell-shaped container (10) is coupled and supported; said bottom part (2) being provided with a middle opening (4) for the flame from the gas burner to get in (50) and surrounded by an inner directing edge (5); and a plurality of circumferential rib-shaped braces (6) for supporting the tips of the skews (30) or baskets (31), such braces being regularly arranged around the middle opening (4) following a circumferential alignment; the bell-shaped container (10) is defined by a cylindrical wall (11) provided with an open lower end (12), which is internally coupled and fixed to the wall (3) of the base platter (2); and a upper wall (13) extending from the cylindrical wall, provided with a wide middle opening (14) for receiving the closing cap (15); said upper wall (13) being further provided with streaks (16) for supporting the skews (30) or baskets (31), arranged correspondingly to the respective circumferential ribs (6) for supporting the tips of the skews (30) and baskets (31) located on the base platter (1), each streak (16) being formed by a rectilinear section radially extending from the middle opening (14) and the introduction and removal of skews/baskets, and an enlarged end for supporting the skews/baskets; said upper wall (13) being further provided with steam outlet streaks (17) each one arranged between streaks (16) for supporting the skews/baskets; the heat diffuser (20) is arranged immediately above the middle opening (4) of the base platter (1) and formed by a lower platter (21); a upper deflector (22); and feet (23); said lower platter (21) features a middle section in the shape of the platter itself (24) which supports an amount of charcoal; and curved, oblong openings (25) arranged around the middle section (24); the upper deflector (22) is disk-shaped and located above the middle section (24) and openings (25) of the lower platter (21); and feet (23) interconnecting the lower platter (21) with the diffuser (22) and featuring sections projected downwards the lower platter (21) and supported on a section of the base platter (1) around the inner edge (5); the skews (30) comprising a preferably flat rod (32), arranged to receive the meat to be roasted and handle (33) located at one rod end; the baskets (31) comprise the middle rod (34); two articulated baskets (35) mounted on the rod between which the meat to be roasted can be fixed, and a handle (36) provided in the rod end; referred to skews (30) and baskets (31) rest with their rod tips (32) and (34) supported over the circumferential braces (6) of the base platter (1); the intermediate extensions of said skew and basket supporting the meat extend vertically along the bell-shaped container (10) and the upper ends of the rods (32) and (34) of said skew and basket close to handles (33) and (36) remain coupled with the streaks (16) of the upper wall (13) of the bell-shaped container.

2)- “ARRANGEMENT FOR A GRILL”, as claimed in claim 1, characterized in that rods (32) and (34) are preferably flat.
